(19) United States
(12) Patent Application Publication
(10) Pub. No.: US 2025/0230331 A1
(43) Pub. Date: Jul. 17, 2025

(54) FABRIC PRETREATMENT SOLUTION

(71) Applicant: EASTERN TECH LLC, Orange, CT (US)

(72) Inventors: Gerald Cantalupo, JR., Toms River, NJ (US); Robert Murphy, Stratford, CT (US); Shawn Liu, Orange, CT (US); Erienne Murphy, Milford, CT (US)

(21) Appl. No.: 19/015,889

(22) Filed: Jan. 10, 2025

Related U.S. Application Data
(60) Provisional application No. 63/621,734, filed on Jan. 17, 2024.

(51) Int. Cl. C09D 11/54; C09D 11/033; C09D 11/101; C09D 11/107; D06P 1/52; D06P 1/54; D06P 3/52; D06P 3/60; D06P 5/00; D06P 5/20

(52) U.S. Cl. CPC C09D 11/54; C09D 11/033; C09D 11/101; C09D 11/107; D06P 1/525; D06P 1/54; D06P 5/002; D06P 5/2005; D06P 3/52; D06P 3/60

(57) ABSTRACT

A pretreatment solution for treating fabric including an aqueous solution of 0.5 weight percent to 15 weight percent of a multivalent cationic salt; 0.1 weight percent to 3 weight percent of a blocked isocyanate crosslinking agent; 0.1 weight percent to 15 weight percent of an acrylic polymer; and 0.2% weight percent to 10% weight percent of an acid.

### CROSS-REFERENCE TO RELATED APPLICATIONS

This application claims the benefit of U.S. Provisional Application Ser. No. 63/621,734 filed Jan. 17, 2024, the entirety of which is herein incorporated by reference.

### BACKGROUND OF THE INVENTION

### 1. Field of the Invention

This disclosure relates to pretreatment solutions for direct to garment printing on and methods of use thereof.

### 2. Description of the Related Art

Fabric pretreatment solutions are commonly used on fabrics before inkjet printing onto the resultant pre-treated fabric during direct to garment (“DTG”) printing. A typical DTG printing process entails pretreating a fabric with a pretreatment solution, curing the pretreated fabric, printing onto the cured pretreated fabric, and curing the printed fabric. Pretreatment solutions generally include additives to enhance the appearance and performance of the final printed fabric. Drawbacks of pretreatment solutions can include a narrow scope of use with regards to fabric types, underlying colors of the fabric, and the color range of inks used in the printing process. Use of pretreatment solutions can fail provide satisfactory print vibrancy, wash and wear durability, and/or acceptable hand feel. Furthermore, after heat treatment of a pretreated fabric, a residue can remain visible on the pretreated area of the fabric. With use of some pretreatment solutions, unwashed, pretreated fabric exposed to ultraviolet (UV) light or heat can discolor leaving undesirable and permanent staining on the fabric.

A need remains for a pretreatment solution that enables printing onto a wide range of fabric types and colors while eliminating visible residue and UV discoloration.

### SUMMARY OF THE INVENTION

A pretreatment solution for treating fabric including an aqueous solution of 0.5 weight percent to 15 weight percent of a multivalent cationic salt; 0.1 weight percent to 3 weight percent of a blocked isocyanate crosslinking agent; 0.1 weight percent to 15 weight percent of an acrylic polymer; and 0.2% weight percent to 10% weight percent of an acid.

A method of direct to garment printing including disposing a pretreatment solution onto a first portion of a fabric to provide a pretreated first portion of the fabric; curing the pretreated first portion of the fabric to provide a cured pretreated fabric; printing an image on a first fraction of the cured pretreated fabric to provide a printed image; curing the printed image to provide a cured printed image on the first fraction of the cured pretreated fabric.

The above described and other features are exemplified by the following figures and detailed description.

### BRIEF DESCRIPTION OF THE DRAWINGS

Referring now to the drawings, which are exemplary embodiments, and wherein the like elements are numbered alike.

FIG. 1 illustrates a flow diagram of an embodiment of a method of direct to garment printing; and

FIG. 2 illustrates a block diagram of a flow diagram of an embodiment of a method of direct to garment printing.

### DETAILED DESCRIPTION OF THE INVENTION

Disclosed herein is a fabric pretreatment solution suitable for a wide variety of fabric colors and types during DTG printing. The fabric pretreatment solution can be disposed a fabric before printing with inks during DTG printing. The pretreatment solution serves as an ink receptive layer to ensure print vibrancy, washability, durability, and satisfactory hand feel. Beneficially, the fabric pretreatment solution does not leave visible residue on fabric and does not stain upon UV exposure or heat exposure. The fabric pretreatment solution provides superior cosmetic appearance and wear performance in comparison to pretreatment solutions on the currently on the commercial market.

“And/or” includes any and all combinations of one or more of the associated listed items.

“Fully cured,” as used herein, refers to a water content of less than 5 weight percent based on the total weight of the material.

“Partially cured,” as used herein, refers to a water content of 5 weight percent to 50 weight percent based on the total weight of the material.

“Fabric pretreatment solution”, “aqueous pretreatment solution”, and “pretreatment solution” are used interchangeably herein to refer to the fabric pretreatment solution. The fabric pretreatment solution is an aqueous solution of selected amounts of at least four components including a multivalent cationic salt; a blocked isocyanate crosslinking agent, an acrylic polymer, and an acid. The pretreatment solution can contain selected amounts of other optional ingredients, namely, resins, solvents/penetrants, humectants, and finishing agents. Expressions of weight percent are with respect to the total weight of the composition.

The multivalent cations can be easily soluble or very soluble in the aqueous pretreatment solution and preferably exist (in solution) in a substantially ionized state so that they are in a form where they are free and available to interact with a fabric when the fabric is exposed to the pretreatment solution. “Easily soluble” as used herein refers to a solubility where approximately 1 to 10 parts of the aqueous pretreatment solution dissolves one part of the solute. “Very soluble” as used herein refers to a solubility where less than 1 part of the aqueous pretreatment solution dissolves one part of the solute.

The multivalent cationic salt can include any salt wherein the multivalent cation of the salt comprises multivalent cations of elements Mg, Ca, Sr, Ba, Sc, Y, La, Ti, Zr, V, Cr, Mn, Fe, Ru, Co, Rh, Ni, Pd, Pt, Cu, Au, Zn, Al, Ga, In, Sb, Bi, Ge, Sn, Pb, or a combination thereof. “Multivalent” indicates an oxidation state of two or more and, for an element “Z”, are typically described as Z²⁺, Z³⁺, Z⁴⁺ and so forth. For brevity, multivalent cations may be referred to herein as Z^{x}. For example, calcium can be used as a multivalent cation in the multivalent cationic salt. The multivalent cationic salt can serve to increase the cationic reactivity of fabric treated with the pretreatment solution. For example, the cationic reactivity of pretreated fabric and increase reactivity with an anionic ink printed on the fabric. In this manner, the multivalent cationic salt can improve colorfastness and print vibrancy of the printed fabric.

In some embodiments, the multivalent cationic salt can be calcium acetate, calcium nitrate, calcium chloride, or hydrates thereof, or a combination thereof. The amount of the multivalent cationic salt can be 0.5 weight percent (wt %) to 15 wt % or 1 wt % to 10 wt % of the total weight of the pretreatment solution.

The term “blocked isocyanate crosslinking agent”, as used herein, refers to any blocked isocyanate or polyisocyanate crosslinking agent that can be used in a digital printing process with fabric. Use of the blocked isocyanate crosslinking agent in the pretreatment solution can improve the washability or washfastness of the printed image on the fabric. The isocyanate group in the blocked isocyanate crosslinking agent can be a blocked di-polyisocyanate, or a blocked tri-polyisocyanate, or a combination thereof.

For some embodiments, the isocyanate group in the blocked isocyanate crosslinking agent can a trifunctional trimethylolpropane (TMP) of toluene diisocyanate (TDI); hexamethylene diisocyanate (HDI), hydrogenated xylylene diisocyanate (H6XDI), isophorone diisocyanate (IPDI), or dicyclohexylmethane diisocyanate (H12MDI), or a combination thereof. For some embodiments, the blocking agent can be diethyl malonate (DEM), diisopropyl amine (DIPA), 1,2,4-triazol (TRIA), 3,5-dimethylpyrazol (DMP) and butanoneoxime (MEKO). For some embodiments, the blocked isocyanate crosslinking agent is a blocked aliphatic isocyanate. The blocked isocyanate crosslinking agent can be 0.1 wt % to 5 wt % or 0.5 wt % to 4 wt % of the total weight of the pretreatment solution.

The acrylic polymer can comprise monomer of methyl methacrylate, butyl acrylate, 2-ethylhexyl acrylate, N-methylol acrylamide, 2-hydroxypropyl methacrylate, acrylamide, acrylic acid, ethyl acrylate, methyl acrylate, methacrylic acid, 2-hydroxyethyl methacrylate, vinyl acrylate, ethylene glycol dimethacrylate, tertbutyl acrylate, styrene, butadiene, or a combination thereof. For example, the acrylic polymer can include monomers of methyl methacrylate, butyl acrylate, and 2-ethylhexyl acrylate each independently 20 wt % to 50 wt % of the total weight of the pretreatment solution. After application of the pretreatment solution to fabric and curing, the acrylic polymer on the cured pretreated fabric serves to provide an ink receptive layer on the fabric to improve wash resistance of printed inks. The acrylic polymer can be 0.1 wt % to 15 wt % or 1 wt % to 10 wt % of the total weight of the pretreatment solution.

The acid of the pretreatment solution can comprise acetic acid, boric acid, lactic acid, hydrochloric acid, hydrobromic acid, nitric acid, sulfuric acid, acetic acid, citric acid, lactic acid, or a combination thereof. The pH of the solution is adjusted to a suitable acidic range to ensure solubility of the components of the pretreatment solution. For example, the acid can serve to adjust the pH of the pretreatment solution to 4 to 6. The acid can be 0.2 wt % to 10 wt % or 1 wt % to 5 wt % of the total weight of the pretreatment solution.

The pretreatment solution can include a solvent humectant to improve the handling characteristics of the pretreatment solution and prevent drying out of equipment parts used in for application of the solution, such as in spray tips of spray equipment. The solvent humectant can also improve the stain protecting effects of the pretreatment solution. The solvent humectant can be 0.5 wt % to 5 wt % of the total weight of the pretreatment solution. In some embodiments, the solvent humectant is a polyalkylene glycol monoalkyl ether. The polyalkylene glycol monoalkyl ether can include an ethylene group, a propylene group, or a combination thereof. In solvent humectant can include triethylene glycol monobutyl ether, propylene glycol methyl ether, dipropylene glycol methyl ether, 2-butoxy ethanol, ethylene glycol, glycerin, or a combination thereof.

Other finishing agents can be included in the pretreatment solution. Finishing agents can include a fragrance, a surfactant, a preservative, a biocide, a dye, or a rheology modifier, or a combination thereof. The finishing agents can be in the fabric pretreatment solution in an amount of 0.01 weight percent (wt %) to 3 wt % of the total weight of the pretreatment solution.

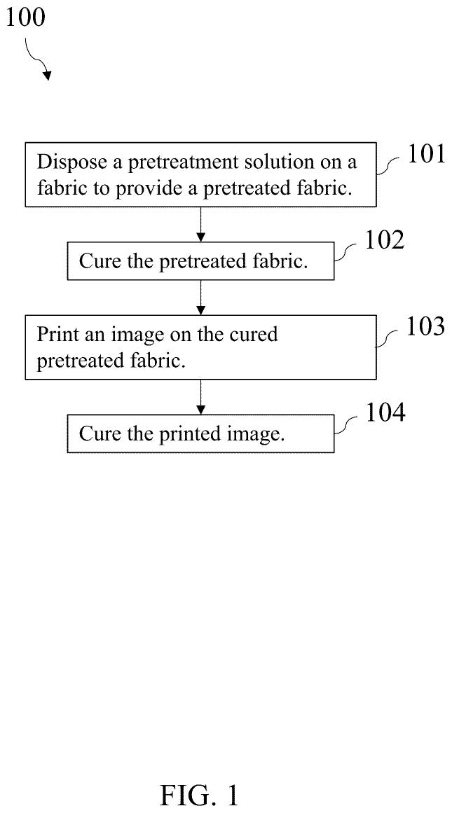

The pretreatment solution can be used to enable printing onto a wide range of fabric types and colors while eliminating visible residue and UV and/or heat discoloration. In FIG. 1, a flow diagram of a method 100 of direct to garment printing is provided. At step 101, the pretreatment solution is disposed on a fabric to provide a pre-treated fabric. The pretreated fabric is cured (step 102) and an image is printed on the cured pre-treated fabric (step 103). After printing of the image, the image is cured to provide the final printed fabric.

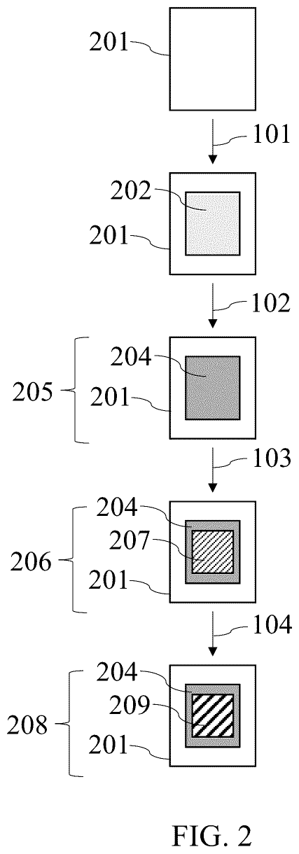

FIG. 2 provides block diagram of a flow diagram of an embodiment of a method of direct to garment printing. At step 101 as shown in FIG. 2, a quantity of pretreatment solution is disposed on the fabric 201 to provide a pretreated first portion of the fabric 202. The pretreatment solution can be applied by spraying, painting, dipping, or other suitable means. After disposing the pretreatment solution on the first portion of the fabric the pretreated first portion of the fabric 202 can be fully or partially cured (step 102) to provide a cured pretreated fabric 205 where the cured pretreatment area 204 is disposed on the fabric 201. At step 103, an image 207 can be printed on some or all of the first fraction of the cured pretreated fabric to provide a printed image on the first fraction of the cured pretreated fabric (shown printed on some of the first fraction of the cured pretreated fabric, item 206). During step 104, the printed image can be cured to provide a cured image 209 on the cured pretreatment area 204 on the fabric 201 (final printed item 208). The curing of the pretreated fabric and/or the cured image can be undertaken with heat, pressure, or a combination thereof. Curing of the pretreated fabric can be performed at 250° F. to 400° F. or 265° F. to 360° F. with a pressure of 0 psi to 80 psi, 1 psi to 80 psi, or 20 psi to 60 psi. Curing the printed image can be performed by irradiation with ultraviolet light or by heating at 250° F. to 400° F. with a pressure of 0 psi to 80 psi.

With use of some pretreatment solutions, unwashed, pretreated fabric exposed to UV light or heat can discolor leaving undesirable and permanent staining on the fabric. The disclosed pretreatment solution can reduce or elimination discoloration of the pretreatment area by UV light. For example, in some embodiments, the pre-treatment solution is not disposed on a second portion of the fabric and the second portion of the fabric has a minimal total color difference after exposure to UV light. Furthermore, a second fraction of the cured pretreated fabric that is not printed with an image (i.e., the area labeled 204 in item 206 of FIG. 2), does not have a macroscopically visible residue from the pretreatment solution.

The pretreatment solution is suitable for use with a variety of fabric types and colors. Fabric types for use with the pretreatment solution include cotton, polyester, or a combination thereof. Fabric colors for use with the pretreatment solution include white, light colors, and dark colors, or a combination thereof. The inks used to printed on a garment pretreated with the pretreatment solution can include inks of white, CMYK [cyan, magenta, yellow, and key (black)] inks, CMYK with white underneath, six-color inks, and so forth.

### Examples

Various pretreatment solutions were applied to different fabric types and fabric colors. A quantity of the pretreatment solution was sprayed on an area of 16″×14″ of the fabric. After the pretreatment solution was sprayed on the fabric, the fabric was cured and exposed to ultraviolet irradiation. The L-A-B delta values for each fabric sample were then measured and the macroscopic appearance of the fabric sample was graded from A to F. The description of the qualitative grading scale, the sample details and testing results are provided in Table. 1.

### Test Solution A

The test solution A includes 0.5 wt % to 15 wt % of a multivalent cationic salt; 0.1 wt % to 3 wt % of a blocked isocyanate crosslinking agent; 0.1 wt % to 15 wt % of an acrylic polymer; and 0.2% wt % to 10% wt % of an acid at a pH of 4 to 6.

### Test Solution B

Control solution B is the use of a control pretreatment solution containing only calcium nitrate as the multivalent cationic salt.

Control solution C is the same as Test solution B with the use of calcium chloride in place of calcium nitrate.

Control solution D is the same as Test solution B with the use of calcium acetate in place of calcium nitrate.

### Qualitative Grade Scale:

A=Less than 5% macroscopically visible residue,
B=macroscopically visible residue over 25% or less of the cured pretreatment area,
C=macroscopically visible residue over 50% or less of the cured pretreatment area,
D=macroscopically visible residue over 75% or less of the cured pretreatment area,
F=macroscopically visible residue over greater than 95% of the cured pretreatment area.

TABLE 1
Visible color differences on fabric
from cured pretreatment solutions.

| | | Spray | L-A-B | |
|---|---|---|---|---|
| Pretreatment | Fabric Type/ | quantity | Delta | Qualitative |
| Solution | Color | in grams | Values | Grade (A-F) |
| Test Solution A | Next Level | 20 | 0.15 | A |
| Control Solution B | 3210 | | 0.67 | B |
| Control Solution C | CVC: Neon | | 0.53 | B |
| Control Solution D | Yellow | | 0.1 | A |
| Test Solution A | Fruit of | | 0.11 | A |
| Control Solution B | the Loom | | 0.41 | B |
| Control Solution C | 3930: Carolina | | 1.4 | C |
| Control Solution D | blue | | 0.1 | A |
| Test Solution A | Fruit of | | 0.23 | A |
| Control Solution B | the Loom | | 1.2 | C |
| Control Solution C | 3930: Athletic | | 1.57 | C |
| Control Solution D | Heather | | 0.2 | A |
| Test Solution A | Next Level | 30 | 0.25 | A |
| Control Solution B | 3210 | | 1.18 | C |
| Control Solution C | CVC: Neon | | 0.89 | B |
| Control Solution D | Yellow | | 0.13 | A |
| Test Solution A | Fruit of | | 0.2 | A |
| Control Solution B | the Loom | | 0.69 | B |
| Control Solution C | 3930: Carolina | | 1.77 | C |
| Control Solution D | blue | | 0.11 | A |
| Test Solution A | Fruit of | | 0.39 | A |
| Control Solution B | the Loom | | 1.48 | C |
| Control Solution C | 3930: Athletic | | 2.22 | D |
| Control Solution D | Heather | | 0.3 | A |

As shown in Table 1, the pretreatment solution of the present disclosure provided less than 5% macroscopically visible residue over the pretreatment area under all printing conditions tested.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A pretreatment solution for treating fabric comprising an aqueous solution of
0.5 weight percent to 15 weight percent of a multivalent cationic salt;
0.1 weight percent to 3 weight percent of a blocked isocyanate crosslinking agent;
0.1 weight percent to 15 weight percent of an acrylic polymer; and
0.2% weight percent to 10% weight percent of an acid.

2. The pretreatment solution of claim 1, wherein the multivalent cationic salt comprises Mg, Ca, Sr, Ba, Sc, Y, La, Ti, Zr, V, Cr, Mn, Fe, Ru, Co, Rh, Ni, Pd, Pt, Cu, Au, Zn, Al, Ga, In, Sb, Bi, Ge, Sn, Pb, or a combination thereof.

3. The pretreatment solution of claim 1, wherein the multivalent cationic salt is calcium acetate, calcium nitrate, calcium chloride, or hydrates thereof, or a combination thereof.

4. The pretreatment solution of claim 1, wherein the blocked isocyanate crosslinking agent comprises blocked di-polyisocyanate, blocked tri-polyisocyanate, or a combination thereof.

5. The pretreatment solution of claim 1, wherein the acrylic polymer comprises monomers of methyl methacrylate, butyl acrylate, 2-ethylhexyl acrylate, N-methylol acrylamide, 2-hydroxypropyl methacrylate, acrylamide, acrylic acid, ethyl acrylate, methyl acrylate, methacrylic acid, 2-hydroxyethyl methacrylate, vinyl acrylate, ethylene glycol dimethacrylate, tertbutyl acrylate, styrene, butadiene, or a combination thereof.

6. The pretreatment solution of claim 1, wherein the acrylic polymer comprises
20 weight percent to 50 weight percent of the total weight of monomers of methyl methacrylate;
20 weight percent to 50 weight percent of the total weight of monomers of butyl acrylate; and
20 weight percent to 50 weight percent of the total weight of monomers of 2-ethylhexyl acrylate.

7. The pretreatment of claim 1, wherein the acid is acetic acid, boric acid, lactic acid, hydrochloric acid, hydrobromic acid, nitric acid, sulfuric acid, acetic acid, citric acid, lactic acid, or a combination thereof.

8. The pretreatment solution of claim 1, wherein the pH of the pretreatment solution is 4 to 6.

9. The pretreatment solution of claim 1, further comprising 0.5 weight percent to 5 weight percent of a solvent humectant and/or 0.01 weight percent to 5 weight percent of a biocide.

10. The pretreatment solution of claim 9, wherein the solvent humectant is a polyalkylene glycol monoalkyl ether, wherein the polyalkylene glycol monoalkyl ether comprises an ethylene group, a propylene group, or a combination thereof.

11. The pretreatment solution of claim 10, wherein the solvent humectant is triethylene glycol monobutyl ether, propylene glycol methyl ether, dipropylene glycol methyl ether, 2-butoxy ethanol, ethylene glycol, glycerin, or a combination thereof.

12. The pretreatment solution of claim 1, further comprising a finishing agent that comprises a fragrance, a surfactant, a preservative, a biocide, a dye, or a rheology modifier, or a combination thereof, wherein the amount of the finishing agent is 0.01 weight percent to 1 weight percent based on the total weight of the pretreatment solution.

13. A method of direct to garment printing comprising:
disposing a pretreatment solution of claim 1 onto a first portion of a fabric to provide a pretreated first portion of the fabric;
curing the pretreated first portion of the fabric to provide a cured pretreated fabric;
printing an image on a first fraction of the cured pretreated fabric to provide a printed image;
curing the printed image to provide a cured printed image on the first fraction of the cured pretreated fabric.

14. The method of claim 13, wherein curing the pretreated fabric is performed at 250° F. to 400° F. with a pressure of 0 psi to 80 psi, wherein curing the printed image is performed by irradiation with ultraviolet light or by heating at 250° F. to 400° F. with a pressure of 0 psi to 80 psi.

15. The method of claim 13,
wherein the pretreatment solution is not disposed on a second portion of the fabric and the second portion of the fabric has a total color difference in comparison to the cured pretreated fabric.

16. The method of claim 13, wherein a second fraction of the cured pretreated fabric that is not printed with the image has less than 5% macroscopically visible residue from the pretreatment solution.

17. The method of claim 13, wherein the fabric is cotton, polyester or a combination thereof.

18. The method of claim 13, wherein the image is printed with white ink, CMYK [cyan, magenta, yellow, and key (black)] inks, CMYK with white underneath, six-color inks, or a combination thereof.
